(19) United States
(12) Patent Application Publication
(10) Pub. No.: US 2026/0034704 A1
(43) Pub. Date: Feb. 5, 2026

(54) FENCES FOR POWER EQUIPMENT

(71) Applicant: SawStop Holding LLC, TUALATIN, OR (US)

(72) Inventor: Alexander J. Hawkinson, Beaverton, OR (US)

(73) Assignee: SAWSTOP HOLDING LLC, TUALATIN, OR (US)

(21) Appl. No.: 19/262,883

(22) Filed: Jul. 8, 2025

Related U.S. Application Data
(60) Provisional application No. 63/679,278, filed on Aug. 5, 2024.

(51) Int. Cl. B27B 27/10; B27B 27/02

(52) U.S. Cl. CPC B27B 27/10; B27B 27/02

(57) ABSTRACT

A fence for power equipment is disclosed. The fence includes a moveable faceplate and at least one clamping mechanism to hold the faceplate in a desired position. The clamping mechanism includes a handle that rotates to clamp and unclamp the faceplate. The handle uses a sloped or cam surface to create a pulling force to clamp the faceplate in position. The handle can be rotated by hand without the use of tools.

### CROSS-REFERENCE TO RELATED APPLICATION(S)

This application claims the benefit of and priority from U.S. Provisional Patent Application Ser. No. 63/679,278, filed Aug. 5, 2024, the complete disclosure of which is incorporated herein by reference.

### TECHNICAL FIELD

The present disclosure relates to fences for power equipment. More specifically, the present document discloses a fence with a sliding face plate and toolless clamping mechanisms that secure the sliding face plate in a desired location. Such a fence is particularly relevant to power equipment such as table saws and band saws for woodworking.

### BACKGROUND

Table saws and band saws are power tools used to cut a workpiece to a desired size or shape. These saws include a work surface or table and a moving blade. In the case of a table saw, a circular blade extends up through the table. In the case of a band saw, a band blade runs in a loop around wheels and through the table. A person uses these saws by placing a workpiece on the table and feeding it into contact with the moving blade to cut the workpiece to a desired size.

Often a person using a table saw or a band saw moves a workpiece into contact with the moving blade by sliding the workpiece along a guide called a fence. The fence mounts to the top of the table and provides a fixed reference surface relative to the blade against and along which the workpiece can slide. The fence helps keep the workpiece moving in a straight path without shifting or rotating. The fence can be positioned at various positions relative to the blade so that a workpiece can be cut to different dimensions.

### BRIEF DESCRIPTION OF THE DRAWINGS

FIG. 1 shows a perspective view of an exemplary fence with a movable face plate according to the present disclosure.

FIG. 2 shows the exemplary fence mounted to an exemplary table saw.

FIG. 3 shows a cropped, top view of the fence mounted to the table saw with the face plate in a first position relative to the fence.

FIG. 4 shows a cropped, top view of the fence mounted to the table saw with the face plate in a second position relative to the fence.

FIG. 5 shows a cropped, top view of the fence mounted to the table saw with the face plate in a third position relative to the fence.

FIG. 6 shows a partially exploded, perspective view of the exemplary fence.

FIG. 7 shows a cropped, front view of the fence mounted to the table saw where the face plate is mounted in the high fence orientation.

FIG. 8 shows a cropped, front view of the fence mounted to the table saw where the face plate is mounted in the low fence orientation.

FIG. 9 shows a sectioned front view of the fence when the face plate is clamped to the fence tube, and includes a magnified callout circle showing the engagement of the clamping bar with the face plate.

FIG. 10 shows a sectioned front view of the fence when the face plate is not clamped to the fence tube, and includes a magnified callout circle showing the disengagement of the clamping bar with the face plate.

FIG. 11 shows an exploded, perspective view of an exemplary clamping actuator assembly.

FIG. 12 shows a perspective view of the front side of an exemplary clamping base.

FIG. 13 shows a perspective view of the front side of an exemplary clamping handle.

FIG. 14 shows a perspective view of the back side of an exemplary clamping handle.

FIG. 15 shows a cropped, side view of the fence tube to illustrate an exemplary positioning slot.

FIG. 16 shows an exploded, perspective view of an exemplary dual lens assembly.

FIG. 17 shows a cropped, exploded, perspective view of the fence tube and an exemplary roller assembly.

FIG. 18 shows a perspective view of an exemplary wedge block.

### DETAILED DESCRIPTION

### I. Introductory Information

The present drawings and written disclosure illustrate and describe various exemplary embodiments of power tools, accessories, mechanisms, components, circuits, processes, and methods. The particular embodiments which are illustrated and disclosed herein are not to be considered in a limiting sense as numerous variations are possible. Rather, the various exemplary embodiments depicted in the drawings and described in detail below are intended to illustrate specific examples and implementations in a variety of different contexts. It will be understood by those of skill in the art that many different variations, modifications, alternatives, and equivalents of these particular exemplary embodiments are possible. Therefore, the drawings and written disclosure are not intended to limit the scope of the claims to the particular forms, arrangements, components, and/or configurations depicted and described herein. Instead, the claims are intended to cover all such variations, modifications, alternatives, and equivalents which are described and suggested within the scope and spirit of the disclosure as it would be understood by those of skill in the art.

While references to “exemplary embodiment”, “alternative embodiments”, “other embodiments”, etc., may appear throughout the written disclosure, repeated occurrences of such references are not intended necessarily to refer to the same embodiment(s). Rather, such references should be understood in the context in which they are presented and with reference to the figures and components with which they are associated within the narrative of the disclosure. Furthermore, reference to certain embodiments is not intended to exclude other embodiments since particular components, elements, circuits, structures, assemblies, processes, and methods described herein may be combined and/or modified in any manner that is suitable and consistent with the disclosure. Moreover, descriptions of variations and alternatives to components, elements, mechanisms, circuits, structures, assemblies, processes, and methods made in the context of one particular embodiment should not be seen as limited to that particular embodiment since such variations and alternatives may be, and typically are, applicable to all embodiments described and suggested herein.

The written disclosure and/or the accompanying claims may refer to structural elements as being “configured to,” or “adapted to,” perform one or more tasks, operations, or functions. Such elements may be referred to as “components,” “circuits,” “assemblies,” “mechanisms,” etc. It should be understood that when such an element is described as being “configured to” or “adapted to” perform such a task or etc., this phrasing is intended to refer to a physical object or structure such as an electronic component (e.g., resistor, capacitor, cable, processor, etc.), or a mechanical component (e.g., fastener, arm, bracket, shaft, mount, housing, etc.), or a plurality of such components interconnected or combined into a circuit, mechanism, or assembly. Furthermore, the phrasing “configured to” or “adapted to” perform a particular task, operation, or etc., is intended to indicate that the structural component or combination of components is arranged, positioned, selected, programmed, connected, combined, and/or designed to perform the particular task or operation stated. Thus, for example, the phrase “a processor component configured to receive an input from a user-input component” means a physical processor with one or more input nodes which may be connected either directly, or indirectly through additional circuit components, to the output of a physical switch, button, knob, or similar component which is operable by a person to produce electrical signals. And further that the input node(s) of the processor are capable of receiving signals of the type which the user-input component produces, so that the processor, while executing software instructions stored in memory is capable of recognizing the signal for its intended purpose and executing further instructions in response to the signal as determined by the stored software. Likewise, the phrase “a motor configured to drive the cutting tool” means a motor with sufficient output power to move the cutting tool in a manner and at a speed appropriate for the corresponding power tool to cut or shape workpieces as intended. Therefore, it should be understood that all references herein of some particular element being “configured to” or “adapted to” perform some operation, task, or function refers to a physical object and not to some intangible element, entity, or process.

In addition, the term “configured to” or “adapted to” does not mean “configurable to” or “adaptable to.” Thus, for example, an unprogrammed processor that is devoid of executable software instructions may be configurable to perform a task, but it should not be considered as “configured to” perform the task within the context of the present disclosure. Instead, if a processor is referred to herein as “configured to” perform a task, that phrasing means the processor includes the necessary executable software instructions, as well as any necessary processing functionality such as analog-to-digital conversion or etc., to perform the referenced task.

To the extent the phrase “in response to” is used herein, the phrase is intended to describe one more factors that produce an effect. However, the phrase is not intended to eliminate the possibility that additional and/or different factors may affect whether or how the effect is produced. Thus, for example, the phrase “the control circuit is configured to start the motor in response to inputs by the operator” does not mean that the input from the operator is necessarily the only input or condition necessary to start the motor. Instead, the phrase is intended to cover the situation where the motor is started solely in response to input by the operator, as well as the situation where the motor is started only when one or more additional conditions or inputs are present in combination with the input by the operator. Furthermore, the phrase is also not intended to convey that the motor can only be started in response to the input from the operator, as other conditions and/or inputs may also cause the motor to start independent of the input from the operator.

If used herein, the terms “first,” “second,” etc., when used to modify structural elements, are not intended to describe any temporal or spatial order, hierarchy, or priority, unless such order, hierarchy, or priority is expressly stated. Thus, for example, the terms “first processor” and “second processor” do not, unless otherwise stated, imply that the component referred to as the “first processor” has any priority or control over the component referred to as the “second processor.” Furthermore, the terms are not intended to imply that the two processors are either identical or non-identical unless explicitly described as such. Instead, the terms are solely intended to convey the presence of two, separate physical processors.

Unless otherwise stated explicitly, the terms “user” and “operator,” when used herein in reference to using or operating a mechanism such as a power tool, are identical and interchangeable. In contrast, the term “person” means any person whether or not the person is using or operating the mechanism in question.

In the drawings and written disclosure herein, numerous specific details are described for a variety of exemplary embodiments to provide a complete and thorough understanding to those of skill in the art. Nevertheless, those of skill in the art will recognize that many aspects of the present disclosure can be practiced without one or more of the specific details. In some embodiments, well-known and/or readily available components, circuits, structures, assemblies, signals, software instructions, and techniques may have not been shown or described in detail to avoid unhelpful complexity which might hinder comprehension of the present disclosure in its entirety. Similarly, unnecessary details and/or selected tangent surface boundary lines may be removed from some drawings of physical components and assemblies to accentuate the structure of the components and assemblies. Additionally, certain figures may include cropped and/or magnified areas to clearly illustrate selected portions of a larger view. Furthermore, drawing requirements and size constraints may require that larger and/or more complex components, features, assemblies, processes, etc., be divided into multiple sections and illustrated using multiple drawings. Such drawings should be viewed and understood as an undivided whole.

### II. Detailed Disclosure

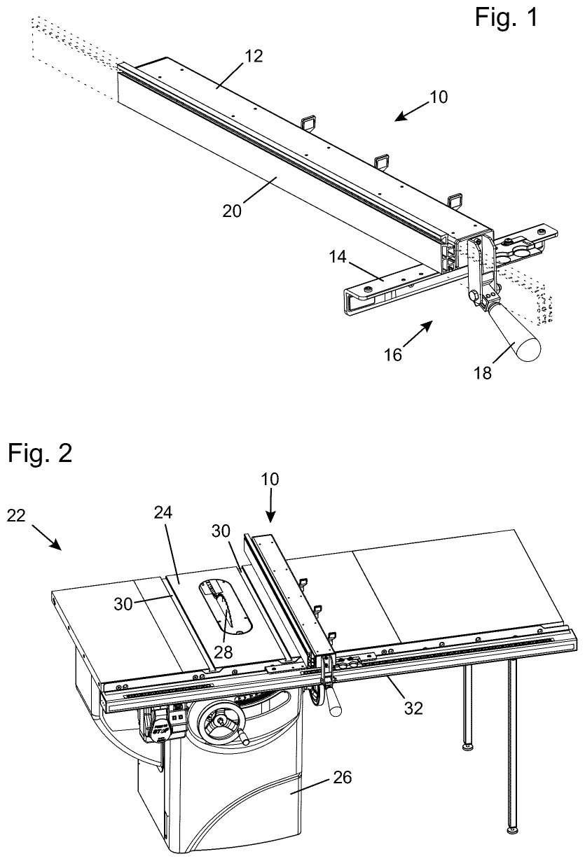

An exemplary embodiment of a fence according to the present disclosure is shown in FIG. 1 and indicated generally at 10. The fence includes an elongate main body or fence tube 12. A fence mounting bracket 14 is mounted to the bottom surface of the front end of fence tube 12 and extends laterally from each side of the fence. A fence clamping mechanism 16 is mounted to the front end of the fence tube and includes a fence handle 18 that is operable by a user to engage and disengage the clamp mechanism. An elongate face plate 20 is slidably mounted to a side surface of the fence tube such that the axial position of the face plate may be adjusted relative to the fence tube by a user.

Exemplary fence 10 is adapted for use on various types of power equipment, such as table saws and band saws, etc., which typically include generally planar tables for supporting workpieces and movable cutting or shaping tools positioned adjacent the table for cutting or shaping workpieces. FIG. 2 shows fence 10 mounted to an example of such power equipment in the form of a table saw 22. Exemplary table saw 22 includes a table 24 which is supported in a generally horizontal orientation by a cabinet 26. A circular saw blade 28 extends partially above table 24. The saw blade is supported by an internal mechanism (not shown) that is adjustable by a user to raise and lower the blade relative to the table. A motor (not shown) is also supported by the internal mechanism and is coupled to rotate the blade about the center axis of the blade.

The table and blade define a workpiece feed direction that is parallel to the top surface of the table and perpendicular to the axis of the rotating circular blade. When a user places a workpiece on the table and moves it along the feed direction into contact with the rotating blade, the teeth of the blade will cut the workpiece. The top surface of the table includes miter slots 30 which are formed in the table and extend parallel to the feed direction. As is well known in the industry, the miter slots are adapted to receive a common accessory known as a miter gauge which engages the miter slots and then slides across the table parallel to the feed direction. A miter gauge enables a user to place a workpiece on the table and in contact with the miter gauge, and then move the miter gauge along the miter slot to move the workpiece in a controlled fashion parallel to the feed direction and into contact with the blade. When using a miter gauge, a user typically positions the workpiece on the table with the longer dimension of a workpiece perpendicular to the feed direction. The user then pushes the miter gauge and the workpiece along the feed direction to make a cut across the shorter dimension of the workpiece which is commonly referred to as a cross cut.

The exemplary table saw also includes an elongate front rail 32 that is mounted to the front edge of the table and that extends parallel to the top surface of the table in a direction perpendicular to the feed direction. Front rail 32 is adapted to support at least one end of a fence, such as exemplary fence 10. As shown in FIG. 2, fence 10 is mounted to the table saw by placing fence mounting bracket 14 on the rail so that the fence tube of the fence extends along the feed direction at least partially across the top surface of table 24. The lateral distance between the face plate and the blade can be adjusted by sliding the fence along the rail. The distance between the face plate and the proximate side of the blade is commonly referred to as the width of cut. Thus, the width of cut can be adjusted by adjusting the position of the fence along the front rail. Once the fence is positioned as desired, it can be locked against further movement by clamping the fence mounting bracket to the rail using fence clamping mechanism 16. A detailed description of exemplary fence mounting bracket 14, exemplary fence clamping mechanism 16, and exemplary front rail 32 can be found in U.S. patent application Ser. No. 12/077,576 filed on Mar. 19, 2008, and published on Oct. 2, 2008, the entire disclosure of which is incorporated herein by reference.

When a user places a workpiece on the table with one edge flush against face plate 20, the user can then slide the workpiece across the table and against the face plate in a controlled fashion parallel to the feed direction and into contact with the blade. If the edge of the workpiece which is placed against the face plate is parallel to the long dimension of the workpiece, the blade will cut the workpiece across its long dimension, which is commonly referred to as a rip cut-especially if the workpiece has a grain that is parallel to the long dimension.

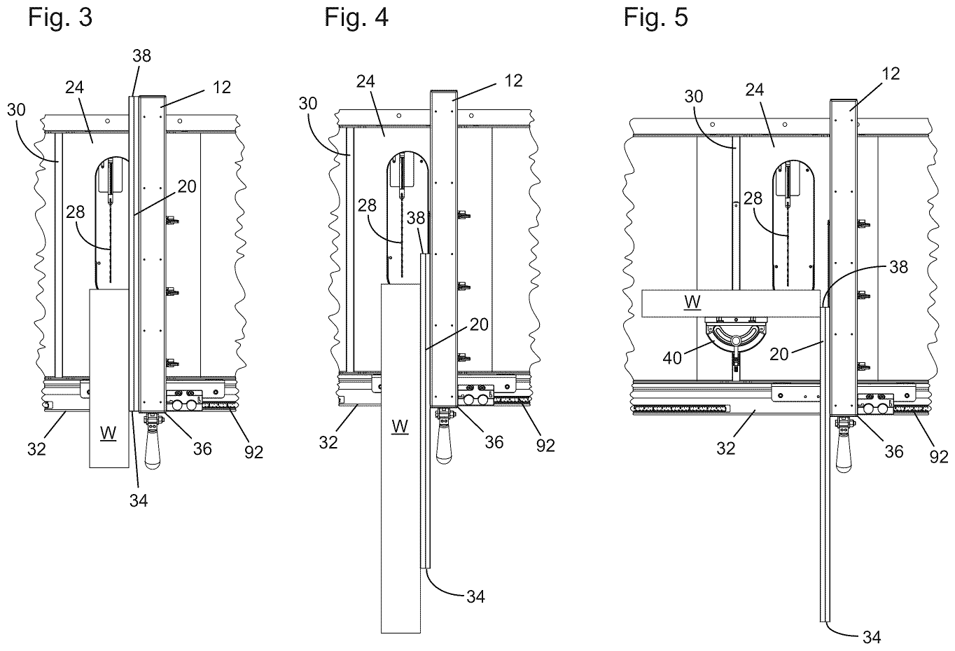

This arrangement is illustrated in FIG. 3 in which an elongate workpiece, designated “W” is placed on the table of the table saw with one long edge positioned flush against face plate 20. The fence is positioned so that the width of cut is less than the short dimension of the workpiece. As a result, when the workpiece is moved across the table along the feed direction and into contact with the blade, the workpiece will be cut by the blade. If the workpiece is moved completely past the blade, the workpiece will be cut into two sections with the rightmost section (as viewed in FIG. 3) having a width (or short dimension) equal to the width of cut. Moreover, the long edges of the rightmost section will be generally parallel since the face plate is generally parallel to the proximate side of the blade. In other words, the width of the rightmost section of the workpiece will be generally uniform over the length of the section. Thus, a user is enabled to cut a workpiece to a desired width which is uniform over the length of the workpiece.

As shown in FIG. 3, exemplary face plate 20 has an elongate length that is approximately equal to the elongate length of fence tube 12, and the forward end 34 of the face plate is adjacent the forward end 36 of the fence tube. Since the fence tube extends from forward of the front edge of table 24 to rearward of the rear edge of the table, the face plate also extends over that distance. Thus, the face plate provides a guide and support region for workpieces that extends across the entire front-to-back dimension of the table.

However, for some workpiece cutting operations, a user may desire the guide and support region provided by the face plate to extend over a different area relative to the blade. For example, when a user is cutting a relatively long workpiece (e.g., substantially longer than the front-to-back dimension of the table) only a small portion of the workpiece may be on the table and in contact with the face plate at the beginning of the cutting operation. In such a situation, the user may desire the guide and support region to be shifted forward to provide increased support to ensure the workpiece is properly aligned relative to the feed direction. To accommodate such operations, the position of exemplary face plate 20 relative to the fence tube is adjustable along the elongate axis of the face plate.

FIG. 4 shows a situation in which the position of the face plate has been adjusted so that the front end of the face plate is substantially forward of the front end of the fence tube. This provides increased initial support for the relatively long workpiece which is aligned against the face plate in preparation for cutting. Although the guide and support region provided by the face plate has been shifted substantially forward of the front end of the fence tube, the rear end 38 of the face plate remains somewhat behind the front edge of the saw blade. Some users may prefer this configuration even cutting relative short workpieces in an effort to reduce the risk of kickback. Alternatively, some users may wish to shift the guide and support region provided by the face plate rearward, in which case the face plate can be positioned so that the front end of the face plate is rearward of the front end of the fence tube. In other words, exemplary fence 10 allows a user to shift the position of face plate 20 anywhere along an extended, continuous range of positions relative to the table and saw blade.

In addition to placing a long edge of a workpiece against the face plate to perform a rip cut, a user may also place a short edge of a workpiece against the face plate to perform a cross cut. In which case, the position of the face plate may be adjusted to the user's desired position as discussed above. This operation may be most effective when the short dimension of the workpiece is not substantially less than the long dimension. However, even in situations where a user prefers to use a miter gauge to guide a workpiece during a cross cut, exemplary fence 10 can still be used to set the width of cut without interfering with the movement of the workpiece during the cutting operation.

This situation is illustrated in FIG. 5 in which a relatively long and narrow workpiece is shown resting on the table with a long edge flush against a miter gauge 40. The fence position has been adjusted to set the desired width of cut between the face plate and the proximate side of the blade, and the position of the face plate has been positioned so that the rear end of the face plate is forward of the front edge of the blade. A short edge of the workpiece is positioned flush against the face plate prior to contact with the blade to set the width of cut. As the user pushes the miter gauge forward, the workpiece will slide past the rear end of the face plate so that the workpiece is no longer in contact with the face plate. This helps to ensure any friction between the workpiece and the face plate is quickly eliminated and does not cause the workpiece to turn at an angle relative to the blade. By holding the workpiece flush against the miter gauge, a user can ensure the workpiece orientation does not change as it moves into contact with the blade, thereby resulting in a straight cross cut of the workpiece with the desired width of cut.

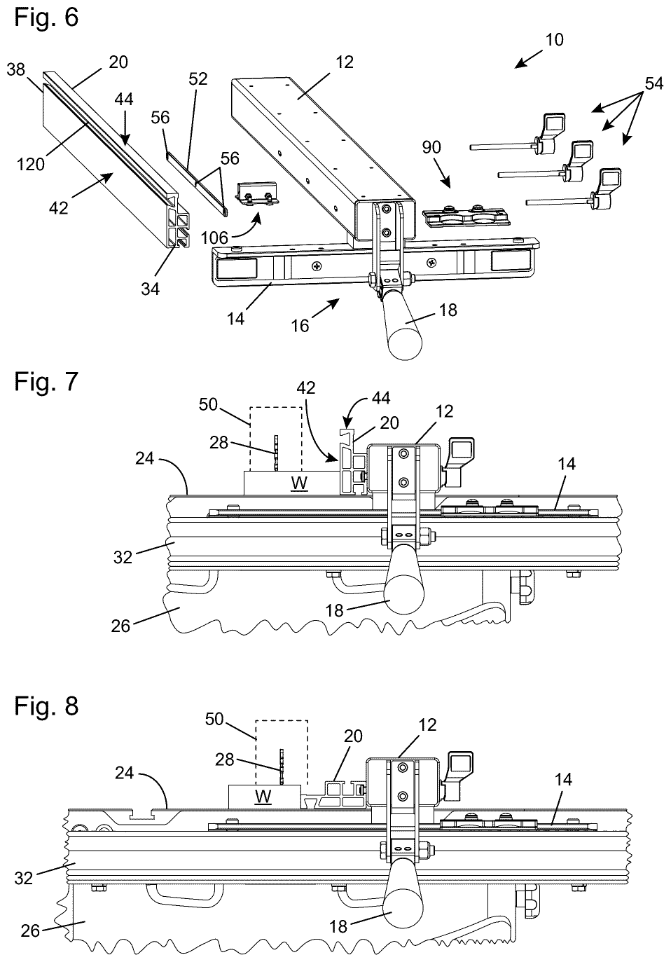

Turning attention now to FIGS. 6-15, the mechanisms of exemplary fence 10 which enable a user to quickly and easily adjust both the position and orientation of the face plate relative to the fence tube can be understood. Exemplary face plate 20 is an elongate structure formed by aluminum extrusion which has a length that is approximately equal to the length of exemplary fence tube 12. In alternative embodiments, the face plate may have a length that is longer or shorter than the fence tube and/or may be formed by other manufacturing processes including plastic extrusion, machining, etc.

The exemplary face plate includes dual, generally planar support surfaces which are referred to herein as “high” support surface 42 and “low” support surface 44, both of which run the length of the face plate. The face plate also includes dual mounting slots which are referred to herein as “high” mounting slot 46 and “low” mounting slot 48, both of which also run the length of the face plate.

When the face plate is mounted to the fence tube using the high mounting slot, the high support surface is vertical and parallel to the side of the fence tube. This mounting configuration is referred to herein as the “high fence” orientation and is best seen in FIGS. 7 and 10. This mounting orientation provides maximum vertical support for a workpiece and is often used when the width of cut is sufficient to prevent interference with any blade guard which might be covering the blade. An example of a typical blade guard profile is indicated schematically at 50 in FIGS. 7-8.

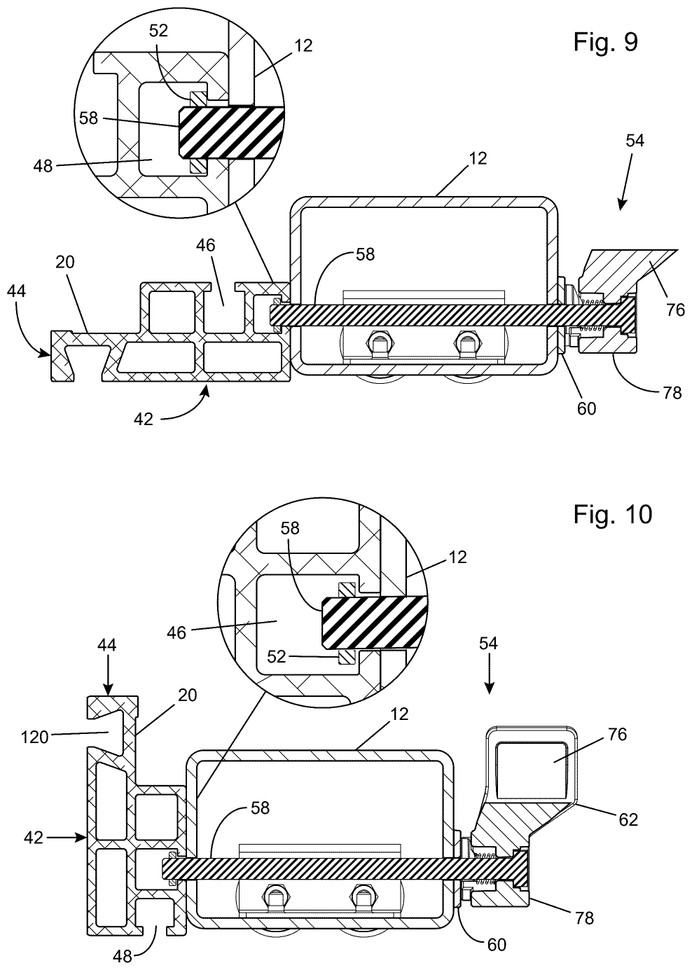

Conversely, when the face plate is mounted to the fence tube using the low mounting slot, the low support surface is vertical and parallel to the side of the fence tube. This mounting configuration is referred to herein as the “low fence” orientation and is best seen in FIGS. 8 and 9. While this mounting orientation provides less vertical support to the workpiece, it prevents interference with a blade guard even when the width of cut is relative narrow. Moreover, when the height of the workpiece on the table is less than the height of the low support surface, the proximate side of the blade guard can rest on the upward facing surface of the face plate while still providing protective coverage of the blade. In other words, the low fence orientation allows both the blade guard and fence to be used even when the width of cut is so narrow as to otherwise cause interference between the face plate and the blade guard.

Exemplary face plate 20 is mounted to the side of fence tube 12 by a face plate clamping mechanism which includes a clamping bar 52 and three clamping actuator assemblies 54. In alternative embodiments, more or fewer than three, or even one clamping actuator assembly may be used. Clamping bar 52 is sized to slidably fit within the high and low mounting slots. Three threaded holes 56 are spaced along the clamping bar. In alternative embodiments, the single clamping bar may be replaced with individual threaded nuts or similar components sized to slidably fit within the mounting slots.

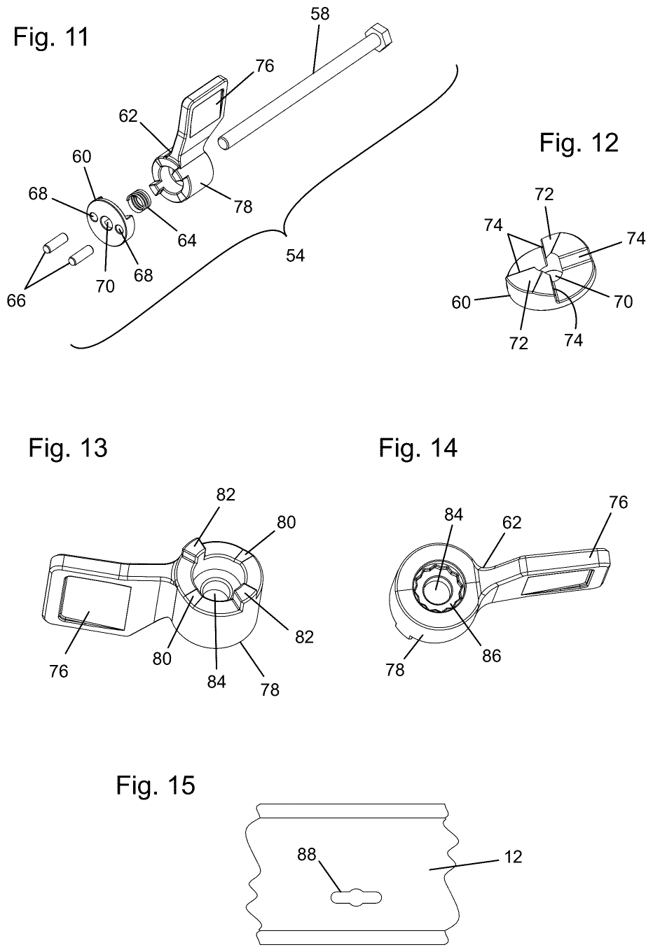

As best seen in FIG. 11, each exemplary clamping actuator assembly includes a clamping bolt 58, a clamping base 60, a clamping handle 62, a retention spring 64, and two alignment pins 66. One end of each alignment pin is received into one of two alignment holes 68 on the back face of clamping base 60. The alignment holes are formed on either side of a central open bore 70 formed through the clamping base. As best seen in FIG. 12, the front face of clamping base 60 is formed with a pair of raised cam surfaces 72, each of which is bounded by a pair of abutment shoulders 74.

Exemplary clamping handle 62 includes a handle portion 76 that extends radially outward from a central hub portion 78. As best seen in FIG. 13, the back face of the clamping handle includes a pair of cam surfaces 80 separated by raised limit posts 82, all of which are formed in a ring on the outer circumference of the back face. An open bore 84 passes through the center of the hub portion. As best seen in FIG. 14, a double-hexagon socket 86 (i.e., a socket formed with 12 points) is formed in the front face of hub portion 78 and centered around bore 84. Socket 86 is sized to receive the hexagonal head of clamping bolt 58. The shank of the clamping bolt passes through both bore 84 and bore 70. Retention spring 64 is a circular compression spring disposed around the shank of the clamping bolt and between the front face of clamping base 60 and the back face of hub portion 76. As best seen in FIGS. 9 and 10, the shank of the clamping bolt is sized to extend from one side of the fence tube to the other, where the threaded end of the clamping bolt is threaded into a corresponding hole 56 on clamping bar 52. In other words, the clamping bar is disposed adjacent the side of the fence tube that is opposite the side where the clamping actuator assembly is disposed.

In the exemplary embodiment, three positioning slots 88 are formed in the sides of fence tube 12 so that each slot on one side aligns with a corresponding slot on the other side. As shown in FIG. 15, the slots are shaped to receive clamping bolt 58 and alignment pins 66. The clamp actuator assemblies are positioned on the side of the fence tube opposite the face plate. Since the slots are identical on each side, the clamp actuator assemblies may be mounted on either side of the fence tube with the clamping bar and face plate on the opposing side. This enables the face plate to be mounted on either side of the fence tube so that exemplary fence 10 can be placed on either side of the saw blade.

When the clamp actuators are mounted to the side of the fence tube the ends of alignment pins 66 which extend from the clamping base protrude into either end of the positioning slots to prevent the clamping base from rotating against the side of the fence tube. However, the clamping handle is free to rotate within an angular range relative to the clamping base which is limited by the engagement of limit posts 82 with a corresponding abutment shoulder 74. In the exemplary embodiment, the range of rotation is approximately 65 degrees. Nevertheless, it will be recognized by those of skill in the art that different rotational ranges may be provided by modifying the shapes and/or numbers of the abutment shoulders and/or limit posts.

When the clamping handle is rotated relative to the clamping base, cam surfaces 80 slide across cam surfaces 72. If the clamping handle is rotated in a clockwise direction (as seen when looking directly at the head of clamping bolt 58), the interaction between the cam surfaces causes the clamping handle to move in an axial direction slightly away from the clamping base. The maximum axial movement is achieved just before the limit posts contact the abutment shoulders. In other words, when the clamping handle is rotated fully clockwise, it's axial position distance from the clamping base and the side of the fence tube is at a maximum. Conversely, when the clamping handle is rotated in a counterclockwise direction, the interaction between the cam surfaces allows the clamping handle to move in an axial direction closer to the clamping base. Since the head of clamping bolt 58 is retained in socket 86, the clamping bolt also moves in an axial direction along with the clamping handle when the clamping handle is rotated.

As best seen in FIGS. 9 and 10, the face plate is held adjacent the side of the fence tube opposite the clamping actuator assemblies by the clamping bar. Since the clamping bar is mounted to the clamping bolts, the distance between the clamping bar and the proximate side of the fence tube will vary when the clamping bolts move axially. For example, when all the clamping handles are rotated fully clockwise, all the clamping bolts move axially and pull the clamping bar closer to the proximate side of the fence tube. Conversely, when the clamping handles are rotated fully counterclockwise, the clamping bolts move in the opposite direction and push the clamping bar further away from the side of the fence tube. Thus, if the clamping bolts are threaded into the clamping bar to the proper depth, the clamping bar will clamp the face plate to the side of the fence when the clamping handles are rotated fully clockwise, and then unclamp the face plate when the clamping handles are rotated fully counterclockwise.

FIG. 9 shows the situation when the clamping handles are all rotated fully clockwise. The clamping bar is pressed against the inner wall of the mounting slot on the face plate and the outer wall of the face plate is pressed against the proximate side of the fence tube. In other words, the face plate is clamped between the clamping bar and the fence tube. If the clamping force is properly adjusted, the frictional force generated between the face plate and both the clamping bar and fence tube will prevent the face plate from moving relative to the fence tube under ordinary conditions. Thus, in the situation shown in FIG. 9, the clamping handles can be understood to be rotated clockwise to their respective “clamped” positions, thereby clamping the face plate to the fence tube.

In contrast, FIG. 10 shows the situation when the clamping handles are rotated fully counterclockwise. The clamping bar is no longer pulled against the inner wall of the face plate mounting slot so that the face plate is no longer clamped to the fence tube. The clamping handles can be understood to be rotated counterclockwise to their respective “unclamped positions,” thereby unclamping the face plate from the fence tube. This allows the longitudinal position of the face plate relative to the fence tube to be adjusted. Once the face plate is properly positioned, the clamping handles can be rotated to their clamped positions to clamp the face plate to the fence tube.

It should be noted that FIG. 10 shows the clamping bar slightly spaced apart from the inner wall of the face plate to emphasize the “unclamped” condition of the face plate. In actuality however, the moderate axial bias exerted by retention spring 64 on the clamping handle tends to urge the clamping handle in an axial direction away from the clamping base. This tends to thereby move the clamping bolt in the same direction. In which case, the clamping bar may still be in contact with the inner wall of the face plate even when the clamping handles are in their unclamped positions. Nevertheless, the force applied by the retention springs is not sufficient to frictionally clamp the face plate to the fence tube. Instead, the face plate is readily slidable against both the fence tube and the clamping bar.

The function of retention spring 64 is to retain the head of clamping bolt 58 in socket 86 when the clamping handle is in its unclamped position. So long as the head of the clamping bolt is retained in the socket, the proper adjustment of the clamping bolt cannot be disturbed. Indeed, the proper adjustment of the clamping bolt is achieved by removing the head of the clamping bolt from the socket so that the bolt can be threaded further into, or partially out of, the corresponding threaded hold in the clamping bar. To make the adjustment, the user first unclamps the face plate and slides it completely off the clamping bar. This allows sufficient clearance so that when the clamping bar is pressed against the side of the fence tube, and the clamping handle is pressed against the clamping base (i.e., overcoming the bias of the retention spring), the head of the clamping bolt will protrude out of the socket. This allows the bolt to be rotated relative to the clamping handle. Once the proper adjustment has been made, the clamping handle can be released so that the retention spring pushes the clamping handle outward until the head of the clamping bolt is retained within the socket. At which point, the face plate can be reinstalled on the clamping bar.

Another note regarding the operation of the clamping mechanisms is that while rotation of the clamping handles causes the clamping bolts to rotate, the clamping bar does not rotate. As a result, the bolts will slightly thread further into and further out of the clamping bar when the clamping handles are rotated. However, the standard thread pitches employed on exemplary clamping bolts 58 cause only slight movement of the clamping bar over the approximately 65 degree rotational range of the clamping handles. This slight axial movement is small compared to the axial movement caused by the interaction of the cam surfaces on the clamping bases and clamping handles. Thus, the clamping and unclamping of the face plate is caused primarily by the cam surfaces in the exemplary embodiment.

It will be appreciated that the exemplary clamping handles may also be understood as clamping levers which are pivotal by hand and without the need of tools. When the levers are in a first position, the face plate is free to slide along the fence tube. When the levers are in a second position, the face plate is clamped to the fence tube against relative movement under ordinary force. Thus, by pivoting the levers between the first and second positions, a user can clamp and unclamp the face plate. In the exemplary embodiment, the lever is pivoted from one position to the other with a pivot angle of 180 degrees or less, and more particularly with a pivot angle of 90 degrees or less, and most particularly with a pivot angle of approximately 65 degrees. However, other angles of 180 degrees or less may alternatively be used.

In summary, exemplary fence 10 is an accessory that is easily adaptable for a variety of different uses and situations. The fence face plate can be quickly and easily adjusted in a longitudinal direction relative to the fence tube without the use of tools and without removing the fence from the power equipment on which it is mounted. Additionally, or alternatively, the orientation of the face plate can likewise be quickly and easily changed between a high fence orientation and a low fence orientation. The exemplary clamping mechanism allows a user to easily clamp and unclamp the face plate by rotating the clamp handles through a relatively short angular range. In contrast to simply tightening one or more bolts to clamp the face plate, the interaction between cam surfaces on the clamping bases and clamping handles generates substantial longitudinal translation of the clamping bolts with relatively small rotations of the clamping handles. Moreover, the cam surfaces are not subject to back-driving or thread loosening which can impair the function of standard threads. Furthermore, when a user rotates the clamping handles to either rotational limit, the user can be certain the face plate is either fully clamped or fully unclamped. In contrast, if the face plate were clamped and unclamped simply by threading a bolt into and out of a threaded hole, there would be no clear limits on how much to turn the bolt. This might lead to insufficient clamping pressure, completely unthreading the bolt from the threaded hole by accident, or both.

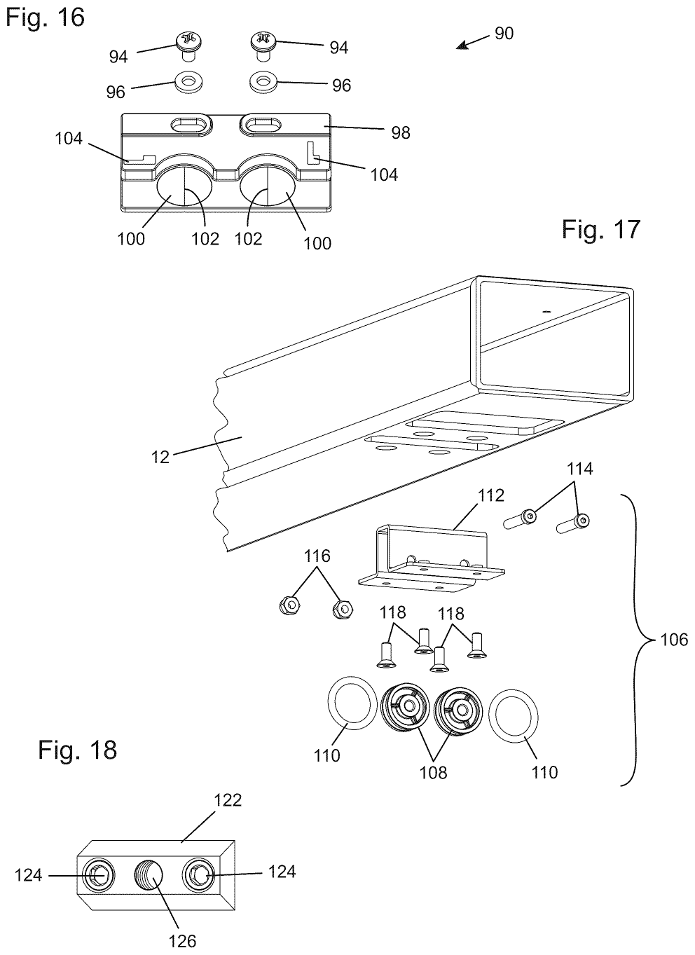

As noted above, a user can set the desired width of cut by sliding exemplary fence along front rail 32 until the distance between the adjacent sides of the face plate and saw blade is equal to the desired width of cut. To determine the width of cut, a user can manually measure the distance between the face plate and the blade. Alternatively, a user can use the dual lens assembly shown in FIG. 16 and indicated generally at 90 to determine the resulting width of cut for a given fence position. Typically, table saws such as exemplary table saw 22 include one or more linear scales or rulers 92 (best seen in FIGS. 3-5) which are adhered or otherwise affixed to the top surface of the front rail. The rulers extend longitudinally along the rail and generally perpendicular to the feed direction.

As shown in FIG. 6, the exemplary dual lens assembly is mounted to fence mounting bracket 14, which supports the lens assembly slightly spaced above the front rail and ruler(s). The lens assembly includes two mounting screws 94 and washers 96 which mount the lens frame 98 to the fence mounting bracket. The two mounting screws pass through elongate openings in the lens frame, thereby allowing a user to fine tune the position of the lens assembly for accurate readings. The exemplary lens frame is formed of an optically clear plastic material and includes two magnifying lenses 100. Each lens has a reticle 102 that runs generally centrally across the lens portion in a direction perpendicular to the underlying ruler(s). Thus, a user is able to look downward through a selected lens and determine the position of the fence by the particular hash mark (sometimes referred to as hatch or tick mark) on the ruler which is directly beneath the reticle of the selected lens.

Adjacent each lens is an orientation indicator 104 which corresponds to the two possible orientations of the face plate. In the exemplary embodiment, each indicator mark is formed with a shape that matches or resembles the outline of the face plate when in the corresponding orientation and when viewed from the front of the table saw. From the perspective shown in FIG. 16, the shape of the leftmost orientation indicator is formed to match the front shape of the face plate when the face plate is in the low fence orientation. Thus, the leftmost orientation indicator may be understood as the low fence orientation indicator. Likewise, the leftmost lens may be understood as the low fence orientation lens. Similarly, the shape of the rightmost orientation indicator in the perspective shown in FIG. 16 is formed to match the front shape of the face plate when the face plate is in the high fence orientation. Accordingly, the rightmost orientation indicator may be understood as the high fence orientation indicator and the rightmost lens may be understood as the high fence orientation lens.

Exemplary lens assembly 90 includes two lenses to allow a user to accurately read the position of the fence regardless of whether the face plate is in the high fence orientation or the low fence orientation. The reticles of the two lenses are spaced apart at a distance that matches the difference in the distance from the proximate side of the fence tube to the two support surfaces of the face plate. In other words, when the face plate is in the high fence orientation, the distance from the proximate side of the fence tube to the high fence support surface is a particular distance—for example: X. However, when the face plate is in the low fence orientation, the distance from the proximate side of the fence tube to the low fence support surface is a different particular distance—for example: Y. The difference in those distances (e.g., Y−X=Z) is equal to the distance between the two reticles. It will be understood that these distances and the difference thereof can have many values depending on the dimensions of the face plate, etc. In the exemplary embodiment, the distance from the side of the fence tube to the high fence support surface is about 28.2 mm while the distance between the side of the fence tube and the low fence support surface is about 68.2 mm. Since the difference between those two distances is about 40 mm, the distance between the reticles of the low and high fence lenses is also about 40 mm in the exemplary embodiment.

When the rulers are correctly placed on the front rail, a user can accurately set the width of cut by sliding the fence along the front rail until the appropriate reticle is aligned directly above the desired reading on the ruler. The correspondence between the relative positions of the high and low fence support surfaces and the relative positions of the reticles of the high and low fence orientation lenses, allows a user to read the current width of cut on the ruler by selecting the appropriate lens and observing which hash mark is directly below the corresponding reticle. The orientation indicators provide visual guides to assist the user in selecting the appropriate reticle depending on the orientation of the face plate. Thus, the exemplary dual lens assembly enables a user to read the width of cut directly from the ruler for both face plate orientations without manually measuring the width of cut and without adding or subtracting from a single reading on the ruler.

As discussed above, the forward end 36 of fence tube 12 is attached to fence mounting bracket 14 which is supported by front rail 32. In other words, the forward end of the fence tube is supported above table 24 by the front rail. However, the opposite or rearward end of the fence tube is supported above the table by a roller assembly 106 which is indicated generally at 106 in FIG. 6. The details of exemplary roller assembly 106 are best seen in FIG. 17. The roller assembly includes two wheels 108, each of which supports a toroidally shaped tire 110 in a semi-toroidal groove formed around the outer circumference of the wheel. In the exemplary embodiment, tires 110 are elastomer o-rings, though other components may alternatively be used. The wheels are rotatably mounted to a roller bracket 112 by axle bolts 114 which pass through the bracket and wheels to thread into axle nuts 116. The roller bracket supports the two wheels side-by-side in a common plane so that the wheels rotate about parallel axes.

The exemplary roller bracket is mounted to the bottom, inner wall of the fence tube by mounting bolts 118 which pass through holes in the bottom of the fence tube and thread into holes in the roller bracket. When the roller assembly is mounted to the fence tube, a portion of each tire protrudes from the bottom of the fence tube. The mounting of the roller assembly internal to the fence tube and the protrusion of the tires below the bottom of the fence tube can best be seen in FIGS. 9 and 10. When exemplary fence 10 is mounted to the front rail, the tires rest on the top surface of table 24 so that the roller assembly supports the rearward end of the fence tube slightly above the table. When a user wishes to adjust the width of cut by sliding the fence mounted bracket along the front rail, the wheels and tires will rotate to provide a low-friction support of the rearward end of the fence tube as it moves above the table. Thus, the entire length of the fence tube is supported slightly above the table. The spacing between the wheel axes is greater than the width of standard miter slots to ensure at least one wheel remains on the top surface of the table when the fence crosses over a miter slot.

In addition to functioning as an accessory for aligning a workpiece to a feed direction and setting a width of cut, exemplary fence 10 can also function as a support for other accessories useful in cutting and shaping workpieces. As just one example, users often desire an accessory which functions to hold a workpiece down against the upper surface of the table. Such accessories are commonly referred to as “hold down” accessories and make take various forms such as feather boards, roller mechanisms, and etc. To support such accessories, exemplary face plate 20 includes a dove tail shaped groove 120 formed in high fence support surface 42, which is best seen in FIGS. 6 and 10. Exemplary groove 120 extends the entire length of the face plate and is positioned near the top of the high support surface. In alternative embodiments, multiple grooves may be used and/or grooves may be formed in different locations on the support surface.

To facilitate mounting various accessories to face plate 20, exemplary fence 10 includes one or more mounting wedge blocks 122 such as shown in FIG. 18. The exemplary wedge blocks are formed with a lateral cross section that matches the profile of groove 120 while having slightly smaller dimensions so as to be slidable within and along the groove. The shape of the wedge block prevents it from being removed from the groove except by sliding the wedge block completely out an end of the groove. Set screws 124 are threaded through laterally spaced holes through the front of the wedge block. Once the wedge block has been positioned as desired along the length of the groove, the set screws can be tightened until the tips of the set screws contact the back wall of the groove and pushes the wedge block against the angled inner surfaces of the groove, thereby frictionally locking the wedge block in place. A threaded hole 126 is formed through the approximate center of the wedge block to allow accessories such as a hold down accessory to be bolted to the face plate. Thus, the groove and wedge block(s) provide a useful mechanism for supporting additional accessories or other components adjacent the workpiece, table, and/or blade.

### INDUSTRIAL APPLICABILITY

The fences, components, and mechanisms described herein are applicable to power equipment, and particularly to table saws and band saws.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A fence for power equipment, the fence comprising:
an elongate main body;
a bar associated with the main body;
a faceplate configured for movement along the bar; and
a clamping mechanism to secure the faceplate in a desired position on the bar, where the clamping mechanism includes a lever configured to be pivoted by hand without the use of tools from a first position where the faceplate is released and free to move along the bar to a second position where the faceplate is secured and held in the desired position on the bar.

2. The fence of claim 1 where the lever may be configured to pivot 180-degrees or less to move from the first position to the second position.

3. The fence of claim 1, where the lever may be configured to pivot 90-degrees or less to move from the first position to the second position.

4. The fence of claim 1, further comprising multiple clamping mechanisms, and where such clamping mechanisms are spaced along the elongate main body of the fence to clamp the faceplate at multiple locations along the faceplate.

5. The fence of claim 1, where the face plate is selectively positionable on the bar in a first orientation and a second orientation, and where the height of the face in the first orientation is greater than the height of the face plate in the second orientation.

6. The fence of claim 5, further comprising a dual lens assembly having a first lens with a first reticle and a second lens with a second reticle that is spaced apart from the first reticle, and where the distance between the first and second reticles is equal to the difference in the heights of the face plate in the first and second orientations.

7. The fence of claim 1, further comprising a wheel assembly having at least two wheels rotatably mounted adjacent a lower surface of the main body, where the wheel assembly is configured to at least partially support the fence when the fence is placed on a horizontal surface.

8. The fence of claim 1, where the face plate includes a slot configured to receive a mounting block for mounting accessories to the face plate.
